(19) United States
(12) Patent Application Publication
(10) Pub. No.: US 2007/0068073 A1
(43) Pub. Date: Mar. 29, 2007

(54) Apparatus for growing plants

(76) Inventor: Antoon Cornelis Richard Holl, Perth, Western Australia (AU)

Correspondence Address: KEVIN J. MCNEELY, ESQ., 5335 WISCONSON AVENUE, NW, SUITE 440, WASHINGTON, DC, 20015, US

(21) Appl. No.: 10/557,470

(22) PCT Filed: May 19, 2004
(86) PCT No.: PCT/AU04/00652

§ 371 Date: Nov. 19, 2006

(30) Foreign Application Priority Data
May 20, 2003 (AU) 2003902454

(51) Int. Cl. A01G 9/02

(52) U.S. Cl. 47/67

(57) ABSTRACT

Apparatus for growing plants (10) comprising a frame (11) having one or more substantially vertical side walls (14) in the form of a rigid sheet of mesh. The sheet of mesh defines an array of openings (20) for receiving a plurality of receptacles (12). The receptacles (12) each receive soil in which a plant is to be grown. Each receptacles (12) is supported by the frame (11) within one of the openings (20) such that an upper end of each of the receptacles (12) is located on one side of the side wall (14) and a lower end of said receptacle (12) is located on a second opposite side of the side wall (14).

### BRIEF DESCRIPTION OF THE INVENTION

The present invention relates to an apparatus for growing plants.

### FIELD OF THE INVENTION

The traditional method of growing plants, such as strawberries, requires sufficient amount of land to be set aside for the plants to be planted at sufficient spacings to ensure adequate growth. Increasing the number of plants grown per area by such methods is difficult and therefore restrictions are placed on the cost effectiveness of such operations both in terms of the value of the land relative to the crop produced and the cost of labour and equipment to cultivate and harvest the crop.

Increasing the number of plants that can be grown in a particular area of land both increases the profits that can be made from the crop and also allows the introduction of crop production in areas where available land may be in short supply. It also makes the possibility of controlling the environment around the crop through the use of enclosures more feasible.

The present invention relates to apparatus for growing plants in which the number of plants which can be grown per area of land is increased significantly over conventional methods. The apparatus of the present invention is of a simple and inexpensive construction, thereby increasing the cost effectiveness of the growing operation and allowing easy installation. Further, the present invention allows for easy modification of the arrangement of plants within the apparatus and therefore provides flexibility in terms of the numbers and types of plants that can be grown.

### SUMMARY OF THE INVENTION

In accordance with one aspect of the present invention there is provided apparatus for growing plants comprising:

a frame having one or more substantially vertical side walls, the or each side wall comprising a rigid sheet of mesh defining an array of openings; and

a plurality of receptacles arranged to receive soil in which a plant is to be grown;

wherein each of the receptacles is supported by the frame within one of the openings such that an upper end of each of the receptacles is located on a first side of the side wall and a lower end of said receptacle is located on a second opposite side of the side wall.

### DESCRIPTION OF THE DRAWINGS

The present invention will now be described, by way of example, with reference to the accompanying drawings, in which:

FIG. 1 is a perspective view of an apparatus for growing plants in accordance with the present invention; and

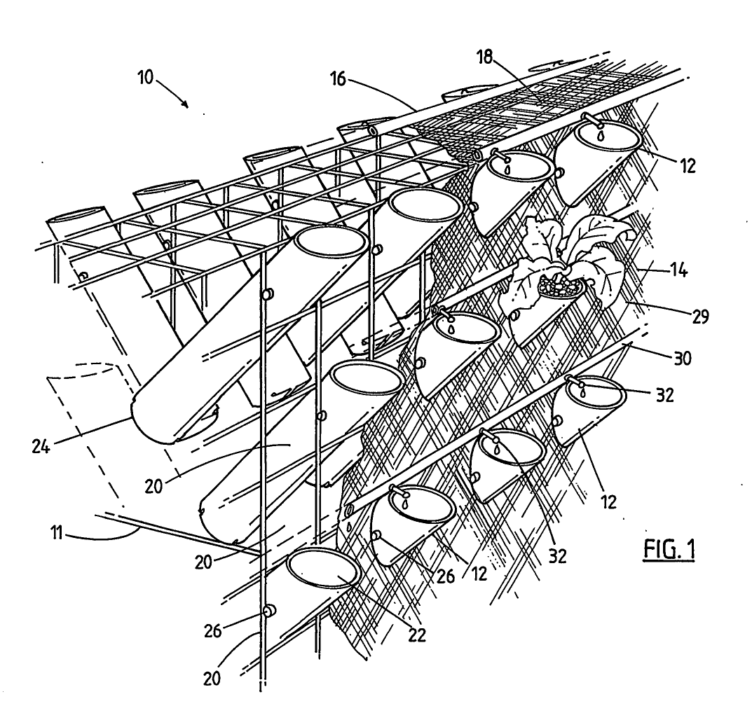

FIG. 2 is a side view of the apparatus for growing plants of FIG. 1.

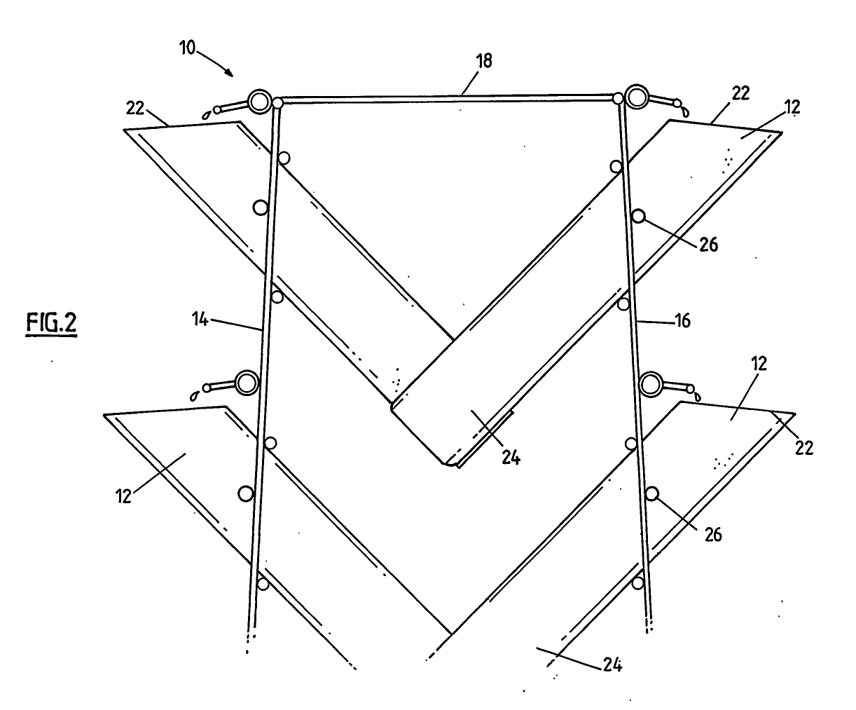

### DESCRIPTION OF THE INVENTION

Referring to the Figures, there is shown an apparatus for growing plants 10 comprising a frame 11 supporting a plurality of receptacles 12. Each of the receptacles 12 is arranged to receive soil in which a plant is grown.

The frame 12 includes a first side wall 14, a second side wall 16 and a top wall 18. The top wall 18 interconnects upper ends of the first and second side walls 14 and 16. The first and second side walls 14 and 16 are preferably angled to the vertical such that the first and second side walls 14 and 16 taper inwardly toward the top wall 18. Each of the first and second side walls 14 and 16 and the top wall 18 comprise a rigid sheet of mesh wherein the mesh defines an array of openings 20. The sheet of mesh comprises a plurality of vertical elongate members and a plurality of horizontal elongate members defining an array of rectangular openings 20.

Each of the receptacles 14 comprises a tube of suitable material, such as PVC pipe, having a first open end 22 and a second closed end 24. The cross-sectional size of the tube is such that the tube can be received within one of the openings 20 in the first and second side walls 14 and 16. Preferably, the length of the receptacles 14 is relatively long with respect to the dimensions of the openings 20 to allow the receptacle to receive sufficient soil for good root growth of the plant.

Each of the receptacles 14 includes securing means which prevent the open end 22 of the receptacle 12 passing through the opening 20. In the present embodiment, the securing means are in the form of transversely extending lugs 26 adjacent the open end 22 of the receptacle 12. The lugs 26 extend outwardly from opposite sides of the receptacle 12 and are sized such that when the closed end 24 of the receptacle is inserted into one of the openings 20, the lugs 26 rest against vertical edges of the opening 20. Further, the receptacle 12 is sized such that when the receptacle 12 is inserted through the opening 20 until the lugs 26 come up against vertical edges of the opening 20, the closed end 24 moves downwardly until the outer surface of the receptacle 12 comes into contact with upper and lower edges of the opening 20. The receptacle 12 therefore rests in a position in which the open end 22 of the receptacle 12 is located adjacent the side wall 14 or 16 on a first side of the side wall 14 or 16 and the closed end 24 of the receptacle 12 is located lower than the open end 22 on a second opposite side of the side wall 14 or 16 as shown in the Figures.

The open ends 22 of the receptacles 12 are angled to a plane perpendicular to a longitudinal axis of the receptacles 12 such that the open ends 22 are generally horizontal in use.

The receptacles 12 are arranged on the first and second side walls 14 and 16 in a plurality of rows. In the embodiment shown in the drawings, the receptacles 12 in each row are located in openings 20 with one opening 20 between each pair of adjacent receptacles 12. Adjacent rows are offset horizontally by the space of one opening 20. The receptacles 12 supported by the side walls 14 and 16 are arranged such that the closed ends 24 of the receptacles supported by the first side wall 14 are arranged adjacent the closed ends 24 of the receptacles supported by the second side wall 16. The arrangement of the receptacles 12 on the first side wall 14 is offset horizontally by the space of one opening 20 relative to that of the second side wall 16, so that the closed ends 24 of the receptacles 12 supported by the first side wall 14 are located between the closed ends 24 of the receptacles 12 supported by the second side wall 16.

The first and second side walls 14 and 16 are provided with a sheet of covering material 29. The sheet of covering material 29 may any suitable material such as a plastic sheeting of a thickness such that the plants grown are prevented from intruding through the side walls 14 and 16 to the space within the frame 11 and such that the receptacles 12 can be pushed through the covering material 30.

The frame 11 may also be provided with a watering system comprising a plurality of conduits 30 supported by the frame 11 arranged to supply water to the receptacles 12. Preferably each receptacle is provided with a drip watering outlet 32 to water the plant in the receptacle 12. Alternatively, an overhead watering system not connected to the frame 11 could be used. In use, the receptacles 12 are arranged in the side walls 14 and 16 of the frame 11 as described above and then filled with soil. The plants to be grown are planted in the soil of each of the receptacles 12 and the frame is preferably placed in an enclosure such as a greenhouse or hothouse. Due to the vertical arrangement of the receptacles 12 on the side walls 14 and 16, a larger number of plants can be grown per area of land than by conventional means. Also, the vertical arrangement makes picking of the fruit from the plants easier than it would be in the case where the plants are grown in the ground. Further, the angled arrangement of the receptacles allows the fruit to hang over the side of the receptacles improving effectiveness of both growth and harvesting. The system 10 also allows the plants to be quickly removed and substituted with a plant of either the same or a different variety.

Modifications and variations as would be apparent to a skilled addressee are deemed to be within the scope of the present invention. For example, while the embodiment shown in the drawings uses cylindrical shaped receptacles 12 and a rectangular array mesh for the side walls 14 and 16 it will be appreciated that receptacles and mesh arrangements of other shapes would be equally suitable.

1. Apparatus for growing plants characterised by comprising:
a frame having one or more substantially vertical side walls, the or each side wall comprising a rigid sheet of mesh defining an array of openings; and
a plurality of receptacles arranged to receive soil in which a plant is to be grown;
wherein each of the receptacles is supported by the frame within one of the openings such that an upper open end of each of the receptacles is located on a first side of the side wall and a lower closed end of said receptacle is located on a second opposite side of the side wall.

2. Apparatus for growing plants in accordance with claim 1, characterised in that the sheet of mesh comprises a plurality of vertical elongate members and a plurality of horizontal elongate members such that each opening of the array of openings is rectangular.

3. Apparatus for growing plants in accordance with claim 1 or 2, characterised in that each receptacle is provided with a securing means adjacent the open end thereof, the securing means engaging with edges of the opening into which said receptacle is received to prevent the open end of the receptacle passing through the opening.

4. Apparatus for growing plants in accordance with claim 3, characterised in that the securing means comprises lugs extending from opposite sides of the receptacle arranged to engage with vertical edges of the opening.

5. Apparatus for growing plants in accordance with claim 4, characterised in that the receptacle is sized such that when the lugs engage with the vertical edges of the opening, the outer surface of the receptacle engages with horizontal edges of the opening.

6. Apparatus for growing plants in accordance with any one of the preceding claims, characterised in that the open end of the receptacle is angled to a plane perpendicular to a longitudinal axis of the receptacle such that the open end is generally horizontal when the receptacle is received in the opening.

7. Apparatus for growing plants in accordance with any one of the preceding claims, characterised in that the frame comprises a first side wall and a second side wall and a top wall interconnecting the first and second side walls.

8. Apparatus for growing plants in accordance with claim 7, characterised in that the first and second side walls are angled to the vertical such that the first and second side walls taper inwardly toward the top wall.

9. Apparatus for growing plants in accordance with any of the preceding claims, characterised in that receptacles are arranged in a plurality of rows in the frame, with each receptacle being separated from adjacent receptacles in row by a single opening.

10. Apparatus for growing plants in accordance with claim 9, characterised in that each row is offset horizontally from adjacent rows in the side wall by the space of a single opening.

11. Apparatus for growing plants in accordance with claims 9 or 10, characterised in that each row in the side wall is offset horizontally from a corresponding row in an adjacent, opposite facing side wall by the space of a single opening.

12. Apparatus for growing plants in accordance with any one of the preceding claims, characterised in that a sheet of covering material is provided to cover the side walls between the receptacles.

13. Apparatus for growing plants in accordance with claim 12, characterised in that the sheet of covering material is constructed of a plastic material such that the receptacles can be pushed through the sheet of covering material into the opening.

14. Apparatus for growing plants in accordance with any one of the preceding claims, characterised in that a watering system is provided, the watering system comprising a plurality of conduits supported on the frame providing a drip-watering outlet to each receptacle.
